(19) United States
(12) Patent Application Publication
(10) Pub. No.: US 2008/0290540 A1
(43) Pub. Date: Nov. 27, 2008

(54) System and method for centering a clay plug on a potter's wheel

(76) Inventors: David Griffin, Charleston, IL (US); Dwain Naragon, Charleston, IL (US)

Correspondence Address: STRASBURGER & PRICE, LLP, 901 MAIN STREET, SUITE 4400, DALLAS, TX, 75202, US

(21) Appl. No.: 11/805,323

(22) Filed: May 23, 2007

(51) Int. Cl. B29C 45/76

(52) U.S. Cl. 264/40.5; 425/266

(57) ABSTRACT

A system and method for centering a clay plug on a potter's wheel before rotation of the potter's wheel includes a rotatable adapter having a central axis aligned with the central axis of the potter's wheel, a rotatable bat whose central axis is aligned with central axis of the rotatable adapter, and a clay plug having a central axis aligned with the central axis of the rotatable bat.

### FIELD

The present invention pertains to a system and method usable with a potter's wheel; more particularly the present invention pertains, to a system and method for centering a clay plug on a potter's wheel before the clay plug is rotated by the potter's wheel for shaping into a vessel.

### STATEMENT REGARDING FEDERALLY FUNDED RESEARCH AND DEVELOPMENT

The invention described in this patent application was not the subject of federally sponsored research or development.

### BACKGROUND

The first use of a potter's wheel is unknown; however, some scholars date the use of a potter's wheel to shape moist clay into vessels as early as 6000 BC. Egyptian mythology suggests that the god Chnum formed the first human beings on a potter's wheel. Fragments of pottery made on a potter's wheel have been found in Iraq and dated to as early as 3000 BC. Some say that the verse in the Old Testament book of Isaiah which reads:
“Yet, O LORD, thou art our father; we are the clay, and thou art our potter; and we all are the work of thy hand,
   refers to the use of a potter's wheel.

Prior art potter's wheels are well known by many who have pursued making ceramic objects as a hobby. Specifically, to make a vessel using a potter's wheel, a moist ball of clay or a clay plug is placed on a flat surface called a bat or batterboard. The clay plug is then rotated by the potter's wheel. During the rotation process, the unformed clay plug is centered by the artisan with respect to the rotation of the potter's wheel by applying pressure with one hand on one side of the rotating clay plug and applying pressure with the other hand on top of the rotating clay plug. Alternatively, the unformed clay plug may be pulled up and down until the artisan perceives, by the use of tactile input through the finger tips, that the axis of rotation of the unformed clay plug is aligned with the axis about which the potter's wheel turns.

Despite the thousands of years during which prior art potter's wheels have been used, the manual centering of the unformed rotating clay plug with respect to the rotation of the potter's wheel remains the biggest challenge for beginning and intermediate level potters. Those new to the creation of vessels from a rotating plug of moist clay must continually practice the craft of shaping the clay plug on a turning potter's wheel to develop the proper feel with their thumbs, fingers, and hands to assure proper centering of the unformed rotating clay plug before a quality vessel can be properly shaped.

In recent years, accessories for use with prior art potter's wheels, as described below, have been developed, but none of these accessories directly addresses the difficulty of properly centering the unformed clay plug on a rotating potter's wheel.

U.S. Pat. No. 4,585,240 describes a holding device which is attached to a potter's wheel for trimming the foot of a vessel after the clay plug has been centered and formed by the artisan into a vessel.

U.S. Pat. No. 4,057,384 describes a mechanical device called the Axner Power Arm which attaches to the potter's wheel to provide additional leverage for an artisan when shaping the clay plug.

U.S. Pat. No. 4,689,001 describes a flat interchangeable bat sold by the American Art Clay Co., Inc.

Accordingly, there still remains a need in the art for a system and method which will properly center an unformed plug of moist clay with respect to a potter's wheel without the need to first rotate the clay plug to manually center the clay plug with respect to the potter's wheel before the clay plug is formed into a vessel.

### SUMMARY

According to the present invention there is provided a system and method for the proper centering an unformed plug of clay with respect to the axis of rotation of a rotating potter's wheel without having to rotate the clay plug and rely on the touch of the artisan's hands to assure proper centering of the clay plug before forming the clay plug into a vessel.

The system and method of the present invention includes a rotatable adapter having a central well formed therein. The rotatable adapter is mechanically connected to the rotating portion of the potter's wheel so that the central axis of rotation of the rotatable adapter is aligned with the axis of rotation of the potter's wheel.

Placed on top of the rotatable adapter is a bat. The bat includes a central tubular section into which the unformed moist clay plug is inserted. The central axis of rotation of the bat is aligned with the axis of rotation of the rotatable adapter. The bottom of the unformed moist clay plug contacts a removable plate within the central tubular portion of the bat. The removable plate is slidably positioned against a ledge formed within the central tubular section of the bat to provide the bottom of a well into which the unformed moist clay plug is inserted.

The bat is mechanically connected to the rotatable adapter so that the bat turns together with the rotatable adapter as a single unit.

Use of the system and method of the present invention is initiated by first filling an extruder/plunger with moist clay. The bottom of the extruder/plunger is sized to mechanically engage and be positioned by a shoulder formed in the top of the bat. Once the extruder/plunger is mechanically engaged and positioned with the bat, the bottom portion of the moist clay within the extruder/plunger is pushed out of the extruder/plunger and into the central tubular section of the bat. The bottom portion of the moist clay exiting the extruder plunger does not pass all the way through the central tubular section of the bat as it is contained therein by coming into contact with the removable plate. The remainder of the moist clay is pushed out of the extruder plunger to form a substantially cylindrical moist clay plug extending upwardly from the bat. Because the central tubular section of the bat is centered with respect to rotatable adapter, which in turn is centered with respect to the rotating portion of the potter's wheel, the axis of rotation of the substantially cylindrical unformed moist clay plug is then aligned with the axis of rotation of the rotatable bat. Thus, the unformed moist clay plug is centered with respect to the potter's wheel before the potter's wheel is ever caused to rotate.

### BRIEF DESCRIPTION OF THE DRAWING FIGURES

A still better understanding of the system and method of the present invention for centering a clay plug on a potter's wheel may be had by reference to the drawing figures wherein:

FIG. 1A is a front perspective view, in partial section, of the system of the present invention;

FIG. 1B is a front perspective view of the ejector;

FIG. 2A is a perspective view of a potter's wheel;

FIG. 2B is a perspective view of the rotatable adapter being placed on the potter's wheel;

FIG. 2C is a perspective view of the rotatable adapter positioned on the potter's wheel;

FIG. 3A is a perspective view of a bat according to the instant invention being placed on the rotatable adapter;

FIG. 3B is a perspective view of the bat according to the present invention ready to receive the moist clay from the extruder/plunger;

FIG. 4A is a perspective view of the extruder/plunger being placed over a block of moist clay;

FIG. 4B is a perspective view of the extruder/plunger with moist clay contained therein positioned on the bat;

FIG. 4C is a perspective view of the moist clay plug on the bat after being pushed from the extruder/plunger;

FIG. 5A is a perspective view of the vessel formed from the clay plug being removed from the bat by the use of a wire cut-off; and

FIG. 5B is perspective view of the removal of the plate and the remainder of the clay plug from within the central tubular portion of the bat.

### DESCRIPTION OF THE EMBODIMENTS

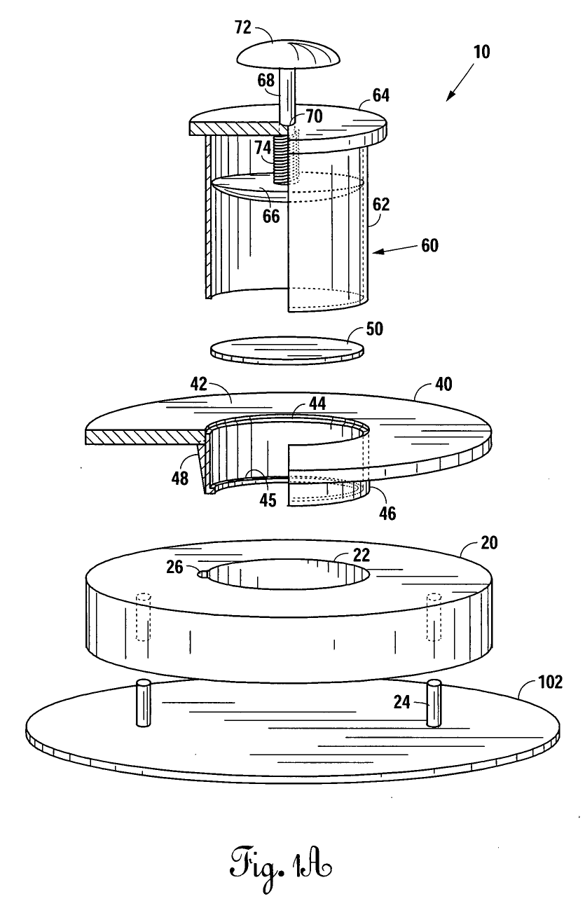

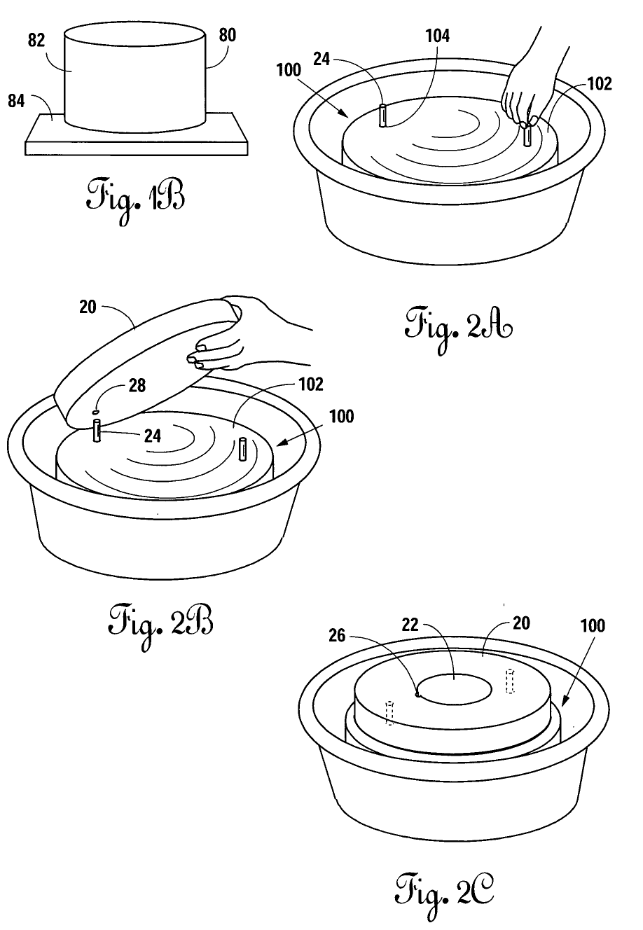

A better understanding of the construction of the system of the present invention 10 for centering an unformed clay plug on a potter's wheel may be had by reference to FIG. 1A. Therein it may be seen that the present system 10 is constructed for use on a potter's wheel assembly 100 (FIG. 2A) before the potter's wheel is caused to rotate. Mechanically connected to the rotating portion 102 of the potter's wheel assembly 100 is a rotatable adapter 20. The rotatable adapter 20 has a well 22 formed in the center portion thereof. The rotatable adapter 20 turns together with the rotating portion 102 of the potter's wheel assembly 100 about the axis of rotation of the potter's wheel because of the pins 24 used to mechanically connect the rotatable adapter 20 to the rotating portion 102 of the potter's wheel assembly 100.

Placed over the rotatable adapter 20 is a rotatable bat 40 according to the present invention. The rotatable bat 40 includes a substantially circular plate 42. In the midst of the substantially circular plate 42 is a central tubular portion 44. In the preferred embodiment, on the outside 46 of the central tubular portion 44 is at least one key 48. The key 48 is shaped and positioned to engage at least one key receiver 26 in the rotatable adapter 20. Thus, when the key 48 and the key receiver 26 in the rotatable adapter 20 are fitted together, one with the other, the bat 40 and the rotatable adapter 20 will rotate together around the axis of rotation of the rotatable adapter 20 as one piece. Mechanical attachments other than a key 48 and a key receiver 26 to cause the bat 40 and the rotatable adapter 20 to turn as a single unit may be used without departing from the scope of the present invention. For example, pins such as discussed above for mechanical connection of the rotatable adapter 20 to the potter's wheel assembly may be used.

Shown also in FIG. 1A is a substantially circular plate or false bottom 50 which is sized for slidable frictional interfitment within the central tubular portion 44 of the bat 40 and against a ledge 45 formed within the central tubular portion 44 of the bat 40. It is the circular plate or false bottom 50 which causes the unformed moist clay 108 to not pass through the central tubular portion 44 of the bat 40.

Positioned above the false bottom 50, shown in FIG. 1A, is an extruder/plunger assembly 60. The extruder/plunger 60 includes a hollow cylinder 62 having a top 64 on its upper end. Within the cylinder 62 is a disc 66 sized to fit within the hollow cylinder portion 62 of the extruder/plunger 60. Connected to the disc 66 is a shaft 68 which passes through a hole 70 in the top 64. On top of the shaft 68 is a handpiece 72. Surrounding the shaft 68 between the top 64 and the disc is a coil spring 74.

Shown in FIG. 1B is an ejector 80 for removal of the bottom of the clay plug from the central tubular portion 44 of the bat 40. The plug ejector 80 is used for applying a substantially upward force on the bottom of the clay plug to move the clay plug out of the central tubular portion 44 of the bat 40 as will be explained below. The plug ejector 80 includes a cylinder 82 sized to fit within the central tubular portion 44 of the bat 40. For stability, the cylinder 82 is located on a flat plate 84 whose footprint is larger than the cylinder 82.

A still better understanding of the system and method of the present invention 10 may be had by a review of its operation.

As shown in FIG. 2A, the system and method of the present invention 10 for centering a clay plug on a potter's wheel is used with a potter's wheel assembly 100. Potter's wheel assemblies 100 typically include a variety of different parts but all potter's wheels generally include a substantially flat rotating surface 102 which is turned by motor or some other source of rotational power about a first substantially vertical axis. In the embodiment shown in FIG. 2A the manufacturer of the potter's wheel assembly 100 has provided holes 104 in the rotating surface 102 into which at least one locating pins 24 is placed.

As shown in FIG. 2B, a rotatable adapter 20 is placed on the rotating portion 102 of the potter's wheel assembly 100. The pins 24 placed in the rotating portion 102 of the potter's wheel 100 in the previous step are aligned with holes 28 formed in the bottom of the rotatable adapter 20. When in place the rotatable adapter 20 rotates as one with the rotating portion 102 of the potter's wheel 100.

As shown in FIG. 2C, the rotatable adapter 20 includes a central well 22 whose purpose will become apparent below. In FIG. 1A and in FIG. 2C, the rotatable adapter 20 is shown with a key receiver 26.

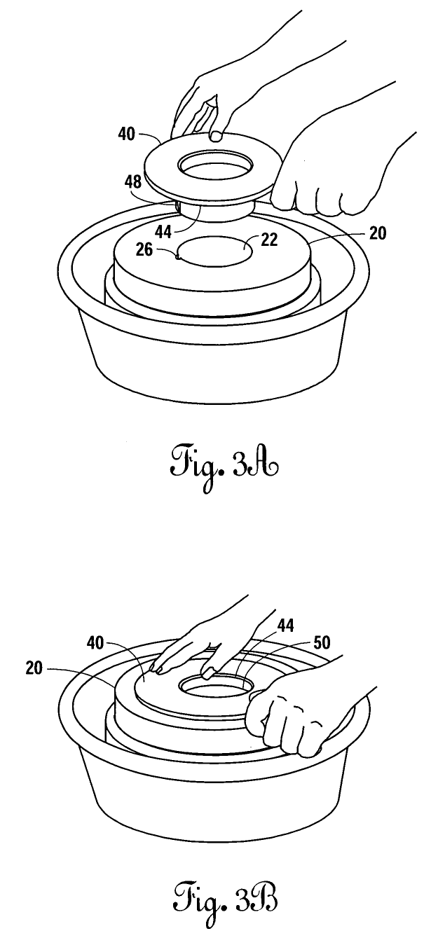

Shown in FIG. 3A and in FIG. 3B is the placement of the substantially circular bat 40 on the rotatable adapter 20. Typically, an artisan is supplied with multiple bats of different sizes, enabling the use of different quantities of moist clay; however, all bats are made to rotate about a second substantially vertical axis. The central tubular portion 44 of the bat 40 fits within the well 22 formed in the center of the rotable adapter 20 joined key 48 which fits snugly within key receiver 26. Those of ordinary skill in the art will understand that pins or slot connections may be used in place of the key 48 and key receiver 26 connection without affecting the operability of the disclosed invention. When the bat 40 and rotatable adapter 20 are put together, the second substantially vertical axis of the bat 40 will be aligned within first substantially vertical axis of the potter's wheel assembly 100.

Located within the central tubular portion 44 of the bat 40 is a substantially flat false bottom or plate 50 which is large enough to slidably engage the interior walls of the central tubular portion 44 of the bat 40 but small enough to be able to slide therethrough. It is the false bottom or plate 50 which retains the unformed moistclay plug 108 in the central tubular portion 44 of the bat 40. The position of the false bottom 50 within the central tubular portion 44 is preferably determined by contact of the false bottom with a ridge 45 formed within the central tubular portion 44.

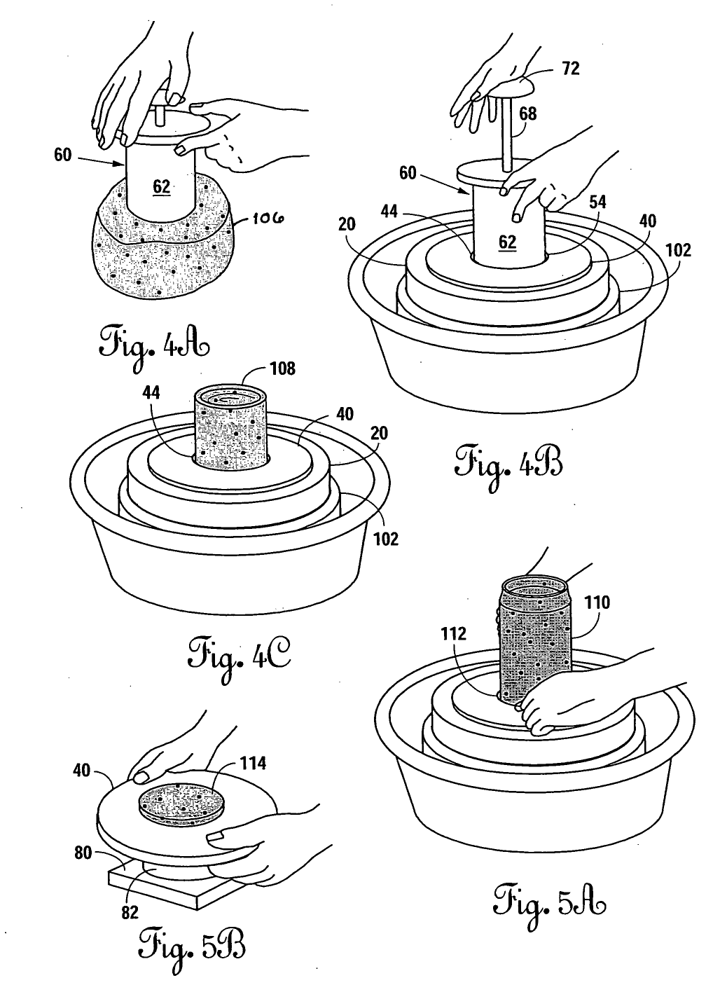

The next step in the use of the system and method of the present invention for centering a clay plug on a potter's wheel is shown in FIG. 4A. Specifically, the clay plug must be placed in the central tubular portion 44 of the bat 40. This is accomplished by using the extruder/plunger 60 shown in FIG. 1A. Specifically, as shown in FIG. 4A the cylinder portion 62 of the extruder/plunger 60 is pushed downwardly over a block of moist clay 106. Such action causes a clay plug 108 to be formed within the cylinder portion 62. The clay plug 108 occupies the space within the hollow cylindrical portion 62 of the extruder/plunger 60. With the clay plug 108 within the cylinder 62, the extruder/plunger 60 is moved to a position over the bat 40 as shown in FIG. 4B.

As shown in FIG. 1A, the cylinder 62 is sized to mate with a shoulder 54 formed in the top of the bat 40. If desired, a locking flange ring (not shown) may be used in place of the shoulder 54. With the bottom of the cylinder 62 seated within the shoulder 54, the handpiece 72 on the top of the shaft portion 68 of the extruder/plunger 60 is depressed. This movement causes the disc 66 on the bottom of the shaft 68 to contact the top of the unformed moist clay plug 108 which in turn causes the bottom portion of the plug of moist clay 108 to move out of the cylinder 62 into the central tubular portion 44 of the bat 40 into contact with the false bottom or plate 50 so that the axis of rotation of the unformed moist clay plug 108 will be aligned with axis of rotation of the bat 40. The remaining portion of the unformed moist clay plug 108 remains above the bat 40 as shown in FIG. 4C. With the completion of the ejection of the bottom of the unformed moist clay plug 108 into the central tubular portion 44 of the bat 40 and the removal of the extruder/plunger 60 from over the unformed moist clay plug 108, the artisan is now ready to cause the rotating portion 102 of the potter's wheel assembly 100 to turn the unformed moist clay plug 108 about an axis which is co-axial with the axis of rotation of the rotating portion 102 of the potter's wheel assembly 100.

Those of ordinary skill in the art will understand that because the central axis about which the rotatable adapter 20 is made to be aligned with the central axis of the potter's wheel assembly 100, the rotatable adapter 20 is centered with respect to the potter's wheel assembly 100. Then, because the central axis about which the bat 40 is made is aligned with the central axis of the rotatable adapter 20, the bat 40 is centered with respect to the rotatable adapter 20. More particularly, the central tubular portion 44 of the bat 40 is centered with respect to the tubular adapter 20. Finally, because the bottom of the unformed moist clay plug 108 is caused to be positioned within the central tubular portion 44 of the bat 40 on the false bottom or plate 50 and the central axis of the unformed moist clay plug 108 is aligned with the central axis of the bat 40 the clay plug 108 is centered with respect to the potter's wheel assembly 100 before the rotatable portion 102 of the potter's wheel assembly 100 ever begins to turn.

Once the artisan has shaped the unformed moist clay plug 108 into the desired shape it is now necessary to remove the completed shaped vessel from the bat 40 for additional work at a later time or for firing in a kiln. Such removal is typically done by using a wire 112 to sever the shaped vessel 110 from that portion 114 of the clay plug 108 which remains resting on the false bottom or plate 50 within the central tubular portion 44 of the bat 40 as shown in FIG. 5A.

As shown in FIG. 5B the bottom portion 114 of the unformed moist clay plug 108 must now be removed from the central tubular portion 44 of the bat 40. This is accomplished by placing the bat 40 over the ejector 80. Because the cylinder portion 82 of the ejector 80 is sized to fit within the central tubular portion 44 of the bat 40, the cylinder portion 82 of the ejector 80 will cause the false bottom or plate 50 and the remaining clay 114 in the central tubular 44 portion of the bat 40 to move up and out of the bat 40. The bat 40 may now be cleaned and made ready for use with another unformed moist clay plug 108. The unused section of the clay plug 114 may be recycled and mixed with a compatible block of moist clay.

While the system and method of the present invention has been described according to its preferred and alternate embodiments, those of ordinary skill in the art will understand that numerous other embodiments of the present invention have been enabled. Such numerous other embodiments shall be included within the scope and meaning of the appended claims.

What is claimed is:

1. An assembly on which an unformed moist clay plug is spun for shaping by an artisan, said assembly comprising:
a source of rotational power;
a rotatable base mechanically connected to said source of rotational power for rotation about a first substantially vertical axis;
a rotatable adapter having a central well formed therein mechanically connected to said rotatable base;
a bat having a substantially circular central well formed about a second substantially vertical axis;
a substantially circular removable plate constructed and arranged for a slidable engagement fit within said substantially circular central well in said bat;
said substantially circular removable plate providing vertical support for said unformed moist clay plug within said substantially circular central well in said bat;
a mechanical connection between said bat and said rotatable adapter which causes said second substantially vertical axis of said substantially circular central well in said bat to be co-axial with said first substantially vertical axis in said rotatable base;
whereby when an unformed moist clay plug is placed within said substantially circular central well in said bat and said bat is mechanically connected to said rotatable adapter, the unformed moist clay plug will be centered and with respect to rotation about said first substantially vertical axis before the unformed moist clay plug is rotated.

2. The assembly as defined in claim 1 wherein said substantially circular removable plate contacts a ridge formed within said substantially circular central well of said bat.

3. The assembly as defined in claim 1 wherein said mechanical connection between said rotatable adapter and said bat includes at least one key formed on the external portion of said substantially circular well and at least one key receiver formed in said central well of said rotatable adapter.

4. The assembly as defined in claim 1 further including an extruder/plunger for placing the unformed moist clay plug within said substantially central well of said bat.

5. A centering system for use on a potter's wheel having a base rotatable about a substantially vertical axis, said centering system comprising:
a rotatable adapter having a central well formed herein, said rotatable adapter being mechanically connected to the rotatable base;
a rotatable bat having a central tubular portion formed about a substantially vertical axis;
a removable plate constructed and arranged for slidable interfitment within said central tubular portion of said rotatable bat;
means for mechanically connecting said rotatable bat to said rotatable adapter so that when connected said substantially vertical axis of said rotatable bat is coaxial with the substantially vertical axis of the base of the potter's wheel.

6. The centering system is defined in claim 5 wherein said removable plate is positioned within said central tubular portion of said bat by contact with a ridge formed within said central tubular portion of said bat.

7. The centering system is defined in claim 5 wherein said means for mechanically connecting said rotatable bat to said rotatable adapter includes at least one key formed on the outside of said central tubular portion of said bat and at least one key receiver formed within said central well of said rotatable adapter.

8. The centering system as defined in claim 5 further including an extruder/plunger constructed and arranged to place a clay plug within said central tubular portion of said bat.

9. A rotatable bat for use with a potter's wheel having an adapter which rotates about a substantially vertical axis and is mounted to a rotatable base portion, said rotatable bat comprising:
a substantially flat surface formed about a substantially vertical axis;
a hollow cylindrical portion formed about said substantially vertical axis;
a plate constructed and arranged to fit within and be retained in a position on said substantially vertical axis by the inner wall of said hollow cylindrical portion;
a mechanical connection between the rotatable bat and the adapter which both causes said rotatable bat to rotate with the adapter and aligns the substantially vertical axis passing through said hollow cylindrical portion with the vertical axis about which the adapter rotates.

10. The rotatable bat is defined in claim 9 wherein said plate is positioned within said substantially hollow portion by contact with a ledge formed with said substantially hollow portion.

11. The rotatable bat as defined in claim 9 wherein said mechanical connection between the rotatable bat and the rotatable base portion includes at least one key formed on the exterior of said hollow cylindrical portion of the rotatable bat and at least one key receiver formed in the rotatable base portion.

12. The rotatable bat as defined in claim 9 further including a shoulder for aligning the axis of an extender/plunger with the axis of the hollow cylindrical portion of the rotatable bat.

13. A method of centering a clay plug with respect to a potter's wheel before the potter's wheel is rotated, said method comprising the steps of:
attaching a rotatable adapter to the rotating portion of a potter's wheel;
attaching a rotatable bat to said rotatable adapter;
placing the bottom portion of a clay plug within a central hollow cylindrical portion of said rotatable bat using a plunger/extruder;
whereby the alignment of the axis of said rotatable adapter with the axis of said rotatable bat with the axis of said clay plug will center said clay plug with respect to the potter's wheel.

14. The method as defined in claim 13 wherein said step of attaching said rotatable bat to said rotatable adapter includes the insertion of at least one key into at least one key receiver.

15. The method as defined in claim 13 wherein the clay plug is retained within said central hollow cylindrical portion of said rotatable bat by a plate positioned against a ridge formed within said central hollow cylindrical portion.

16. The method as defined in claim 13 wherein said plunger/extruder is positioned with respect to said rotatable bat by a shoulder formed at the top of said central hollow cylindrical portion of said rotatable bat.
